(19) United States
(12) Patent Application Publication
(10) Pub. No.: US 2014/0082530 A1
(43) Pub. Date: Mar. 20, 2014

(54) DOCUMENT LAYOUT

(71) Applicants: Joao Batista S. De OLIVEIRA, Porto Alegre (BR); Isabel H. Manssour, Porto Alegre (BR); Ricardo Farias Piccoli, Canoas (BR); Nicole Cogo, Porto Alegre (BR); Rodrigo Chamun, Porto Alegre (BR)

(72) Inventors: Joao Batista S. De OLIVEIRA, Porto Alegre (BR); Isabel H. Manssour, Porto Alegre (BR); Ricardo Farias Piccoli, Canoas (BR); Nicole Cogo, Porto Alegre (BR); Rodrigo Chamun, Porto Alegre (BR)

(21) Appl. No.: 13/619,798

(22) Filed: Sep. 14, 2012

(51) Int. Cl. G06F 3/0484

(52) U.S. Cl. CPC G06F 3/0484
USPC 715/762

(57) ABSTRACT

Techniques related to document layout are presented herein. In some examples, document items are automatically distribute within a free-form area in response to a user modification of the spatial position of another document item in the free-form area. The distribution of document items is performed based on forces between document items modeled after physical laws.

### BACKGROUND

Documents containing a plurality of document items are commonplace in the present digital information era. Such documents may include, for example, at least one text item and/or at least one picture item. Examples of such graphical documents include greeting cards, brochures, photo albums, and marketing collaterals.

Authoring solutions for laying out such graphical documents may be based on static templates produced by graphic designers. Those templates may be filled with content provided by a user. However, these templates may be expensive to create and may be difficult to adapt to different purposes, media sizes or customers.

Recent years have seen considerable advances on automatic document generation and adjustment, but providing non-specialists with a pleasant interface for laying out documents has always been a challenge: editors may have too many operations or may be complicated, turning the task of designing a simple document such as a greeting card into a laborious experience.

### BRIEF DESCRIPTION OF THE DRAWINGS

In order that the present disclosure may be well understood, various examples will now be described with reference to the following drawings.

FIG. 1 schematically shows an environment in which various examples may be implemented.

FIG. 2 schematically shows graphical aspects of a graphical user interface through which various examples may be implemented.

FIG. 3 schematically shows a block diagram illustrating systems for laying out free-form documents according to examples.

FIG. 4 schematically shows a block diagram illustrating computer readable media according to examples.

FIG. 5 shows a flow diagram illustrating examples of managing a GUI to enable a user to lay out a free-form document.

FIG. 6 shows a flow diagram illustrating examples of laying out a free-form document containing a plurality of document items.

FIG. 7 shows a flow diagram illustrating examples of laying out a free-form document containing a plurality of document items.

FIGS. 8A to 8C show a sequence of snapshots of a GUI portion illustrating the automatically caused displacement of a text item in response to the user displacement of a picture item.

FIG. 9 shows a diagram schematically illustrating an example of wall forces acting on a document item.

FIG. 10 shows a diagram schematically illustrating an example of anchoring a document item to a specific location.

FIG. 11 shows a diagram schematically illustrating an example of anchoring between document items.

FIGS. 12A and 12B schematically show interaction between two document items.

FIG. 13 shows a flow diagram illustrating examples of refreshing the position of document items in a GUI during laying out a free-form document.

### DETAILED DESCRIPTION

In the following, numerous details are set forth to provide an understanding of the examples disclosed herein. However, it will be understood that the examples may be practiced without these details. Further, in the following detailed description, reference is made to the accompanying figures, in which various examples are shown by way of illustration. While a limited number of examples are illustrated, it will be understood that there are numerous modifications and variations therefrom.

In this regard, directional terminology, such as “top,” “bottom,” “front,” “back,” “left,” “right,” “vertical,” etc., is used with reference to the orientation of the figures being described. Because disclosed components can be positioned in a number of different orientations, the directional terminology is used for purposes of illustration and is in no way limiting. In the drawings, the dimensions of layers and regions are exaggerated for clarity of illustration. Like numerals are used for like and corresponding parts of the various figures. While a limited number of examples are illustrated, it will be understood that there are numerous modifications and variations therefrom.

As set forth above, providing a pleasant interface for laying out documents is a challenge. In the foregoing, techniques for laying out free-form documents are disclosed. A free-form document is a document in which position and size of a plurality of document items can be custom designed by a user. A free-form document might include by default some specific constraints. That is, document items may only be placed at some specific areas. For example, the free-form document may include lines or grids for guiding placement of document items. Further, such specific areas may be for some specific types of document items. For example, a free-form document may include an area for receiving only picture items. In other examples, the free-form document is to loosely receive document items. That is, document items may be positioned freely within the document.

In at least some examples herein, document items referred to above as components of free-form documents may include at least one text item and at least one picture item. A force interaction model based on physical laws may be associated to the document items. In at least some examples herein, a user is enabled to modify the spatial position (e.g., by insertion, displacement or resize of the item), via a graphical user interface (GUI), of a first document item within a free-form area. In response to the user caused modification of the spatial position of the first document item, the GUI displaces a second document item within the free-form area. The motion of the second document item is engendered according to forces between document items modeled after physical laws. More specifically, a trajectory of document items may be computed based on the user input and according to a force interaction model associated with the document items.

According to examples herein, the GUI is to automatically distribute document items within a free-form area in response to a user modification of the spatial position of another document item in the free-form area, the distribution of document items being performed based on forces between document items modeled after physical laws. Thereby, modifying the spatial position of document items makes other items react by moving, and a chain-effect of several editing steps is avoided. A free-form area refers to the area in which items of the document can be placed by a user. Generally, a free-form area corresponds to the area of the document being layout. A free-form area may also correspond to a constrained area within the document being laid out.

This manner of enabling laying out a free-form document facilitates creation of documents in a quick and intuitive way. More specifically, it is facilitated a better, easier experience at designing loosely-formatted documents. A variety of content combinations (text, images, backgrounds and decorative items) and document form factors can be used to create different documents. Further, some examples herein are aimed to assist small business owners in designing their own leaflets, and enable users with no experience in graphic design to produce their own personalized greeting cards, calendars, photo albums and others.

Force-directed methods as described herein may be used to allow document items to float freely on the free-form area as new document items are inserted, resized or moved around, so that the user (designing a simple brochure for his shop, for example) sees a page where items are well placed (e.g., the items are spread and do not overlap). Thereby, the user may concentrate on placing a single item knowing that existing items will react to it and place themselves on better positions. In some examples, items float on the page and react to each other, trying to be as far away from each other as possible. In some specific examples, a physical model is based on electrical repulsion, and document items are assigned charges according to their respective sizes. The physical model may be adapted for the sake of an easier manipulation of the document items.

Examples herein may include some further features such as, but not limited to, anchoring a document item to a specific position, or anchoring a document item to another (for example, to move a picture and a price tag together easily). After the user is done, a printable document may be generated as a PDF file.

The following description is broken into sections. The first, labeled “Environment,” describes an exemplary environment in which various examples may be implemented. The second section, labeled “Components,” describes examples of various physical and logical components for implementing various examples. The third section, labeled as “Operation,” describes steps taken to implement various examples.

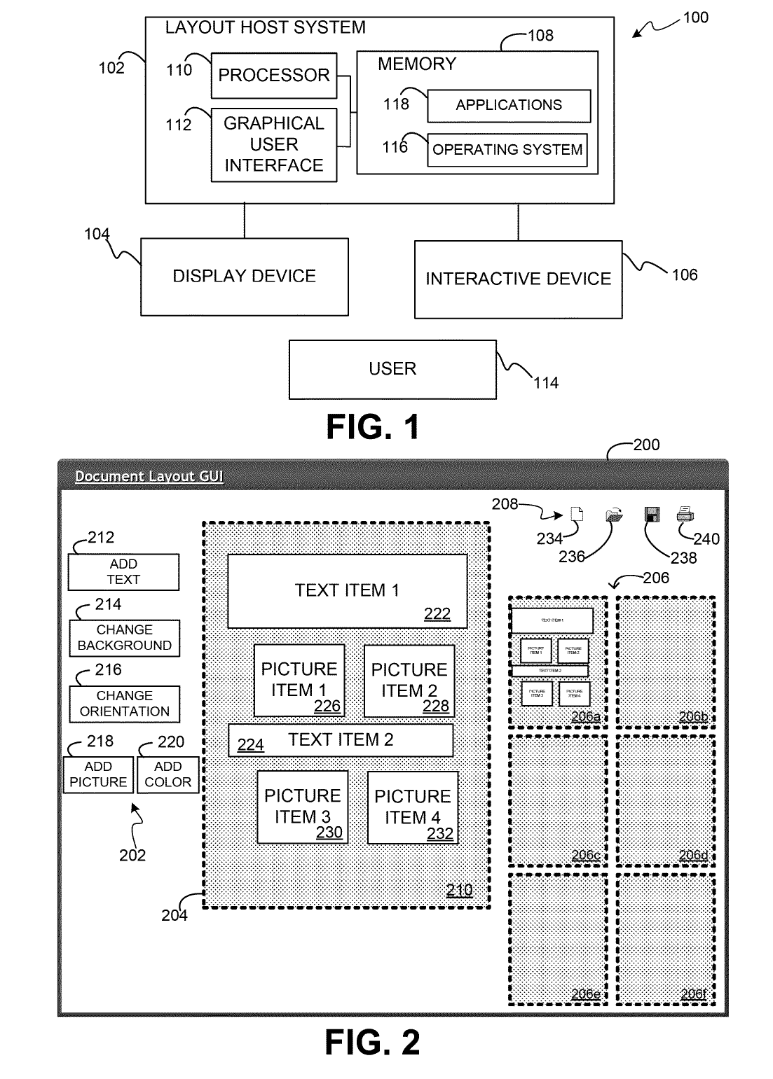

ENVIRONMENT: FIG. 1 depicts an environment 100 in which various examples may be implemented. It will be understood that environment 100 is merely illustrative and that examples herein may be implemented in a variety of environments. Environment 100 includes a layout host system 102, a display device 104 and an interactive device 106.

In the example of FIG. 1, layout host system 102 is shown to include memory 108, processor 110, and graphical user interface (GUI) 112. Processor 110 represents generally any processor configured to execute program instructions stored in memory 108 to perform various specified functions. GUI 112 represents generally any software interface designed to enable layout host system to interact with a user 114 via display device 104 and interactive device 106 (e.g., a mouse or a touch panel) in order to enable user 114 to interactively layout a document as described herein. A specific example of a GUI is illustrated below with respect to FIG. 2.

Memory 108 is shown to include operating system 116 and applications 118. Operating system 116 represents a collection of programs that when executed by processor 110 serve as a platform on which applications 118 can run. Examples of operating systems include, but are not limited, to various versions of Microsoft's Windows® and Linux®. Applications 118 represent program instructions that when executed by processor 110 function as an application that manages GUI 112. Applications 118, when executed, may also function as a service that uses data communicated from interactive device 106 or other computer system for interactively laying out a document as described herein, that service returns uses the data to dynamically compute a document layout and returns it to the user via display device 104.

Display device 104 may be constituted any display device that enables to visually display the graphical aspects of GUI 112 in order to enable user 114 to interactively layout a free-form document as described herein. Examples of such display devices include, but are not limited to, a computer monitor or an LCD display of a hand-held device. Interactive device 106 may be constituted by any interactive device that enables user 114 to enter a user input to GUI 112. Examples of such interactive devices include, but are not limited to, keyboards, computer mouse, or touch panels. Display device 104 and interactive device 106 may be integrated into a single device such as the touch panel of a smart phone or a computer tablet.

FIG. 2 illustrates the graphical aspects of a GUI 200 through which various examples may be implemented. It will be understood that there are a variety of GUIs that can be used to implement examples described herein. GUI 200 is shown to include a set of layout controls 202, a free-form area 204 of a document 210, a document preview display area 206, and a set of document controls 208.

Layout controls 202 include controls that enable a user to modify a layout of document 210. In the illustrated example of FIG. 2, layout controls 202 are shown to include an “add text” control 212, a “change background” control 214, a “change orientation” control 216, an “add picture” control 218, and an “add color” control 220. “Add text” control 212 is to enable a user to add a text item box within free-form area 204. “Add picture” control 218 is to enable a user to add a picture from his own picture collection. “Change background” control 214 and “add color” control 220 are to enable a user to add decorative items to free-form area 204. These decorative items may be configured not to affect the interaction between document items. “Change orientation” control 216 is to enable a user to switch between portrait and landscape orientations. It will be understood that a GUI that implements examples herein may include a different set of layout controls as illustrated with respect to FIG. 2.

Free-form area 204 corresponds to the area of document 210 in which document items may be placed and modified. In the illustrated example, free-form area 204 is sized to correspond to a page of the document. In other examples, free-form area 204 may be sized to correspond to only a portion a page of document 210. In the illustrated example, some document items are shown to be already placed within free-form area 204 such as text items 222, 224 and picture items 226,228,230, 232. Text items correspond to free-form fields including text. Picture items correspond to free-form fields including a pictured. In this example, the document items are shown to have a rectangular shape. It will be understood that document items may have any shape type such as, but not limited to, an oval shape, a polygonal shape.

A GUI engine is responsible to distribute the items within free-form area 204 based on a user input modifying the spatial position of any of the document items and according to a force interaction model based on physical laws as further described below.

Document preview display area 206 includes a downsized representation of pages 20a to 206f of the document being laid out. In the illustrated example, only page one of the document includes documents items. Other pages of the document are represented blank. A user can layout a page of document 210 different as the one being currently displayed at free-form area 204 by selecting that page in document preview display area 206. Upon user selection, GUI 200 updates free-form area 204 for displaying the content of the selected page.

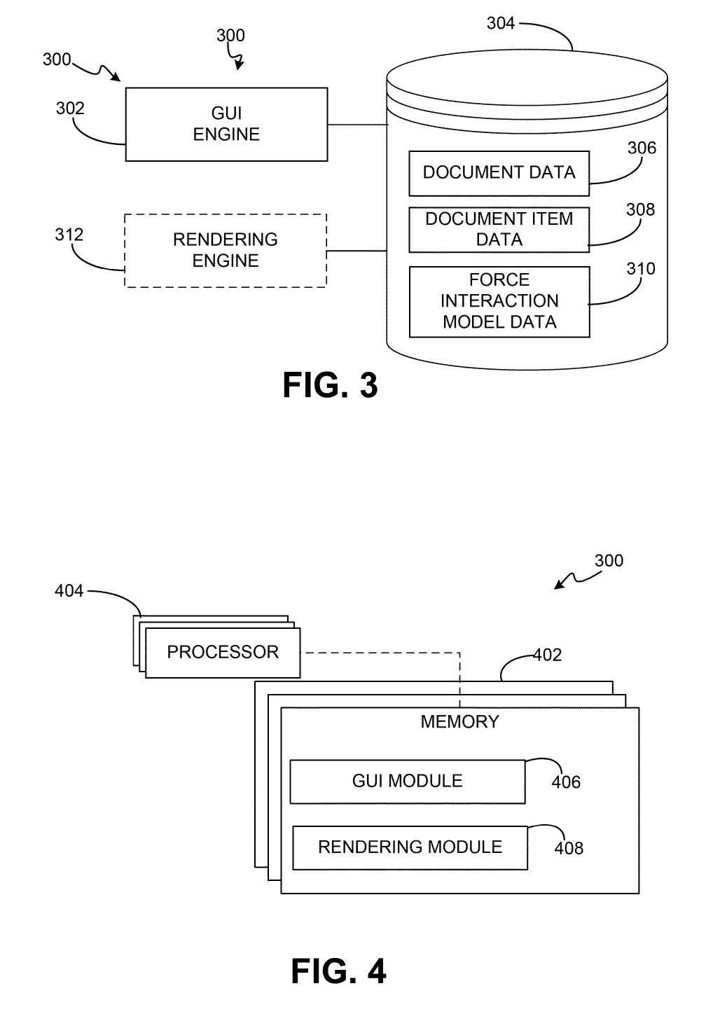

Set of document controls 208 is shown to include a new document control 234, an open document control 236, a save document control 238, and a print control 240. Open document control 236 is to enable a user to create a new document. Save document control 238 is to enable a user to save a document being currently modified. Print control 240 is to enable a user to print a laid out document. Printing may include causing a hardcopy device to produce a printed copy of the laid document. Printing may also include causing creating of a device independent representation of the document (e.g., a PDF file). In particular, after finishing a document, the user can produce a PDF file intended as a printing material, using a print option that renders the document into a PDF. Generation of a device independent representation is illustrated below with respect to FIG. 3. It will be understood that a GUI that implements examples herein may include a different set of set of document controls as illustrated with respect to FIG. 2.

COMPONENTS: FIGS. 3 and 4 depict examples of physical and logical components for implementing various examples. FIG. 3 depicts a system 300 for laying out a free-form document containing a plurality of document items.

In the example of FIG. 3, system 300 includes GUI engine 302. GUI engine 302 represents generally any combination of hardware and programming configured to manage a GUI (e.g., GUI 112, or GUI 200) for enabling lying out of free-form documents as described herein. For example, GUI engine 302 may automatically distribute document items (e.g., items 222, 224, 226, 228, 230, 232 shown in FIG. 2) within a free-form area (e.g., free-form area 204) in response to a user modification of the spatial position of another document item in the free-form area. The distribution of document items is performed based on forces between document items, the forces being modeled after physical laws.

More specifically, and referring also to FIG. 1, GUI engine 302 may manage GUI 112 to enable user 104 to modify, via GUI 104, the spatial position of a first document item within a free-form area (e.g., free-form area 204 shown in FIG. 2). Further, GUI engine 302 may cause the GUI to displace a second document item within the free-form area in response to the user caused modification of the spatial position of the first document item. The motion of the second document items is engendered according to the forces between document items modeled after physical laws.

According to examples, once the user interacts with a document draft containing a plurality of document items, GUI engine 302 may associate with the document items a force interaction model based on physical laws. Via GUI 112, GUI engine 302 may receive a user input to modify the spatial position of a first document item within a free-form area associated with the document layout. For example, the user may displace or resize one document item through interactive device 106. GUI engine 302 may compute a trajectory of the document items in the document draft based on the user input and according to the force interaction mode. Finally, GUI engine 302 may cause the document items in the document draft to move in GUI 112 according to the computed trajectories. More specifically, GUI 112 may be graphically updated to provide a visual feedback to the user of the displacement of document items.

System 300 is built to respond to the user events mentioned herein, as well as the physical simulation described below, which might be carried in real-time for facilitating user interaction. System 300 may carry out simulation steps to compute new position for document items, if item distribution is necessary.

To perform the tasks above, GUI engine 302 may access data associated with the particular data type of a document to be laid out. Such document data may include, for example, document size, specific constraints for a specific document type (e.g., a limited free-form area), or specific document item types associated with the document type. This force data may be recorded in data store 304 as part of document data 306. Further, GUI engine 302 may access data associated with document items for instantiating document layouts. Such document item data may include, but is not limited to, item type, item size, item position, and item values (i.e., a set of RGB values associated with a picture, or a set of string data associated with a text item). This item data may be recorded in data store 304 as part of document item data 308. Further, GUI engine 302 may access data related to the force interaction model in order to associate forces with document items. This force data may be recorded in data store 304 as part of force interaction model data 310.

According to some examples herein, system 300 may further include a rendering engine 312. Rendering engine 312 represents generally any combination of hardware and programming configured to generate a device independent representation of a document laid out as described herein. More specifically, once a user is finished with the layout of a document, the user can produce a device independent representation of the document (e.g., a PDF file) through rendering engine 312. Rendering engine 312 may perform this task by using a document description given as a page rectangle (W, H) and a set of item rectangles (xcᵢ, ycᵢ, wᵢ, hᵢ) for each item i; xc₁ represents position of an item rectangle along the x axis, ycᵢ represents position of an item rectangle along the y axis, wᵢ represents item's width, hᵢ represents item's height.

Rendering engine 312 may place content over each rectangle independently by using an external rendering engine. For example, a rendering engine such as, but not limited to, LATEX, Scribus or iText Java library can be used to place pictures and/or textual content inside each rectangle. Generally, any external rendering engine may be used as long as they support some programming capabilities, such as font resizing in a text box.

To place pictures, rendering engine 312 may scale the width and height of a picture to the rectangle size. In such examples, it may be advantageous that GUI engine 302 manages the GUI such that the GUI is responsible for preserving the original picture's aspect ratio as the user resizes a picture. Alternatively or in addition thereto, GUI engine 302 or rendering engine 312 may perform automatic cropping of pictures for ensuring that the picture fits in the corresponding item's rectangle. In other examples, a user may be enabled to adjust how a picture fits in the corresponding item's rectangle by enabling him to crop, orientate and resize pictures within the rectangle.

For text items, attributes such as font type and color may be defined by a user for each different text. In some example, text may be treated as chunks that are completely contained in their enclosing rectangle, the font sizes being automatically computed so that the text completely fills the rectangle. Automatic justification and line breaking may also be implemented for rendering text items. In some examples, a simple line-break algorithm may be implemented. Examples of such algorithms are described by Hurst et al in the article titled Minimum Sized Text Containment Shapes, published in DocEng '06: Proceedings of the 2006 ACM symposium on Document engineering, pages 3-12, New York, N.Y., USA, 2006. ACM. It will be understood that there are a variety of techniques for rendering text items.

In the foregoing discussion of FIG. 3, various components were described as combinations of hardware and programming. Such components may be implemented in a number of fashions. For example, referring to FIG. 1, the hardware portions may, depending on the example, be implemented as processor 110. The programming portions, depending on the example, can be implemented by operating system 116, applications 118, or combinations thereof.

In another example, referring to FIG. 4, the programming may be processor executable instructions stored on a non-transitory memory media 402 and the hardware may include a processor 404 for executing those instructions. Memory 402 can be said to store program instructions that when executed by processor 404 implement system 300 of FIG. 3. Memory 402 may be integrated in the same device as processor 404 or it may be separate but accessible to that device and processor 404.

In one example, the program instructions can be part of an installation package that can be executed by processor 404 to implement system 300. In this case, memory 402 may be a portable medium such as a CD, DVD, or flash drive or a memory maintained by a server from which the installation package can be downloaded and installed. In another example, the program instructions may be part of an application or applications already installed. Here, memory 402 can include integrated memory such as a hard drive.

In FIG. 4, the executable program instructions stored in memory 402 are depicted as GUI module 406 and rendering module 408. GUI module 406 represents program instructions that when executed cause the implementation of GUI engine 302 of FIG. 3. Rendering module 408 represents program instructions that when executed cause the implementation of rendering engine 312 of FIG. 3.

FIGS. 3 and 4 depict various physical and logical components. Various components illustrated in FIGS. 3 and 4 are defined at least in part as programs, programming, or program instructions. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Examples can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

It will be understood that the functionality of the various physical and logical components described above may be distributed over a plurality of computing elements. For example, portions of GUI module 406 may be stored on plurality memory components that may be integrated in the same system or distributed over a plurality of interconnected systems. Further, the hardware portions implementing GUI engine 302 may be implemented in a plurality of processors, each of them processing partially the implementation of the engine. For example, GUI engine 302 may be implemented in a cloud computing environment.

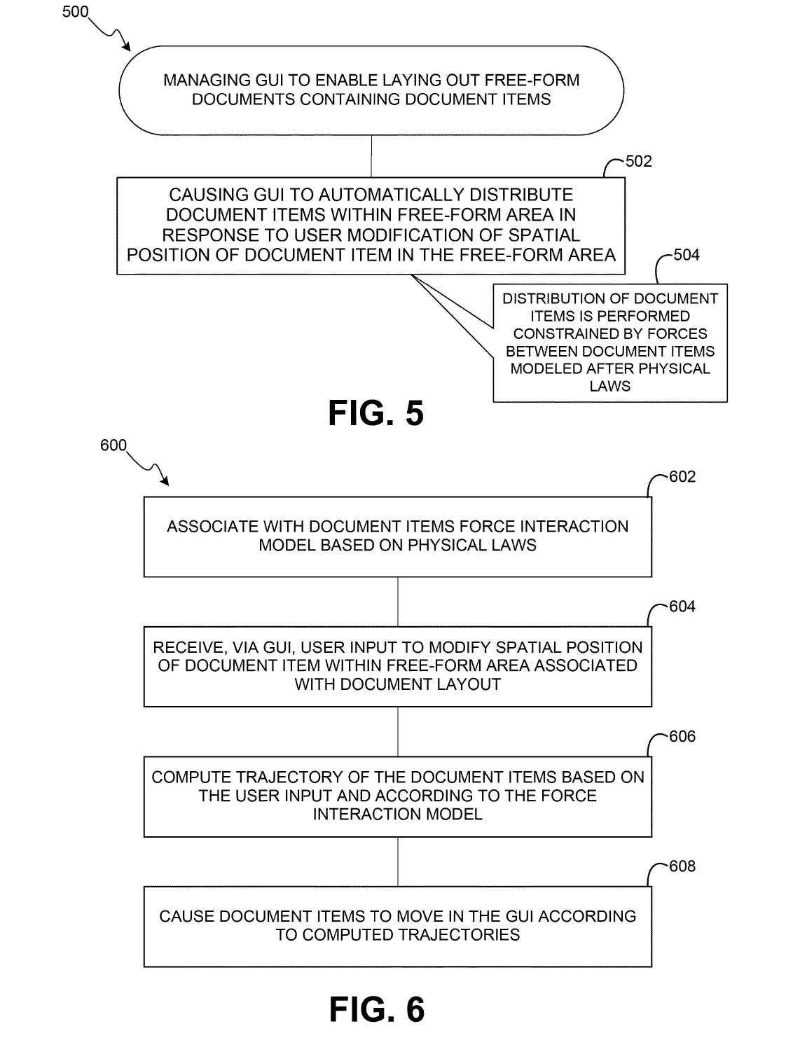

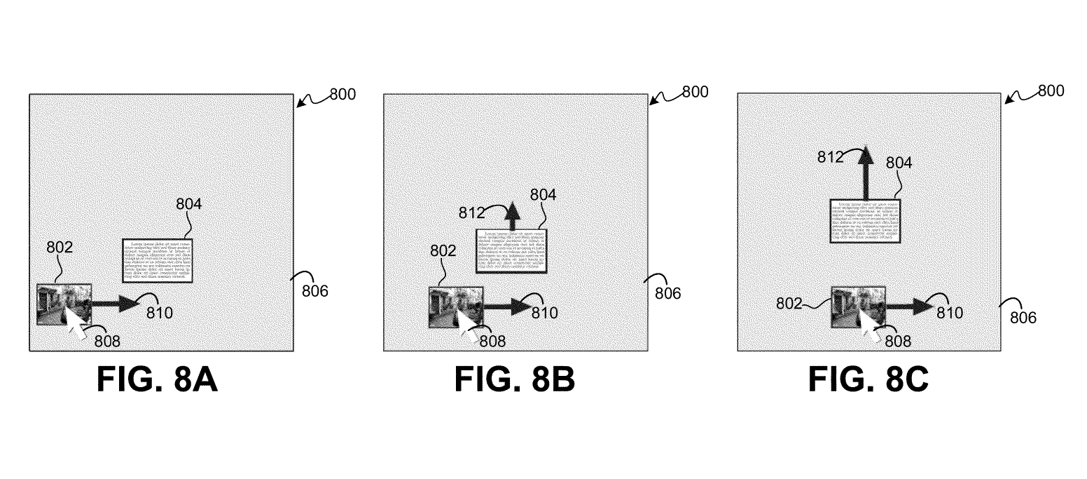

OPERATION: FIGS. 5 to 7, and 13 are exemplary flow diagrams that implement examples of methods for laying out free-form documents. In discussing FIGS. 5 to 7, and 13 reference is made to the diagrams of FIGS. 1 to 4 to provide contextual examples. Implementation, however, is not limited to those examples. Reference is also made to the examples depicted in FIGS. 8A to 12B. Again, such references are made simply to provide contextual examples.

Referring to FIG. 5, flow diagram 500 illustrates examples of managing a graphical user interface (GUI) to enable a user laying out of a free-form document containing a plurality of document items. Referring to FIGS. 1 and 2, the GUI may be constituted by GUI 112 or GUI 200. At block 502, the GUI is caused to automatically distribute document items within a free-form area in response to a user modification of the spatial position of another document item in the free-form area. Document item distribution is subjected to condition 504, namely that the distribution of document items is performed based on forces between document items modeled after physical laws. Referring to FIG. 3, GUI engine 302 may be responsible for implementing block 502.

In some examples, for constructing a layout from the scratch, a user may be initially presented with an empty document associated with a free-form area. The final document is then constructed interactively, as the user inserts or manipulates document items within the free-area. Generally, any number of pages can be used to create a document. In some examples herein, each page is independent, and no attempts are made to perform automatic pagination or flowing items between pages.

However, under some circumstances, pagination may impose additional forces to the overall virtual physical system which may cause instabilities. In some examples herein, a page is treated continuously, so that document items at a boundary of a page may be allowed to slide to the opposite boundary of the page. One manner of enabling that a page is treated continuously is to that a rectangular page as being folded along its both main directions, forming a torus-like structure. In such case, there are four possible distance measures between two items u and v. In other words, in the virtual space represented by the torus, there are four different trajectories for joining two elements on the torus. In some examples herein where such torus is considered, for calculating the forces as described below, the minimum distance along the torus surface between u and v is used. In other examples herein, automatic pagination and flowing of items may be allowed for enabling a convenient layout of a document.

In examples herein, items already placed in a page semi-continuously interact with each other. Semi-continuously interaction refers to the fact that a GUI generally refreshes the visual representation of a document at specific refreshing times. At the same time, a user can still interact with the system, performing, for example, any of the following actions: (i) inserting new items into the page; (ii) deleting items from the page; (iii) moving items around; or (iv) resizing items.

According to some examples herein, the document items are loosely distributed. That is, document items are distributed freely within the document without any by-default placement constraint (e.g., columns or grids) associated with a document type. Further, document items may be classified into hierarchical groups of items for facilitating their placement together in specific document areas.

In other examples, document items are distributed according to by-default placement constraints associated with a document type. For example, a user may layout a document that, as template, includes certain areas in which document items may be placed. At the time of distributing document items, such constraints are also considered such that document items are placed according to the document template.

FIG. 6 shows a flow diagram 600 illustrating examples of laying out a free-form document containing a plurality of document items. Flow diagram 600 illustrates specific blocks that facilitate the automatic distribution of documents set forth above with respect to block 502 in FIG. 5. Referring to FIG. 3, GUI engine 302 may be responsible for implementing the blocks in flow diagram 600.

At block 602, a force interaction model based on physical laws is associated with document items. A force interaction model based on physical laws as used herein is understood as a set of model data that can be used to link a force acting on a document item. These forces may originate from other document items or to specific constraints set to a document item (e.g., an anchoring point). The force interaction model facilitates calculating trajectories of document items in response to, for example, variation in the position of one of the document items. Some specific examples of force interaction models are described below in sub-section “Examples of Force Interaction Models.”

At block 604, a user input is received to modify the spatial position of a document item within a free-form area associated with the document layout (e.g., free-form area 204 depicted in FIG. 2). The user input may be received via an interactive device such as interactive device 106 depicted in FIG. 1. According to some examples herein, modifying the spatial position of a document item may include at least one of inserting the document item in a free-form area, moving the document item, or resizing the document item.

At block 606, trajectory of the document items is computed based on the user input and according to the force interaction model. More specifically, a modification of the spatial position of a document item may disrupt an equilibrium position according to the force interaction model in the set of document items in a document layout. Consequently, using the force interaction model, trajectories for reaching a new equilibrium position of document items may be computed. Some examples of how to compute trajectory of the document items are described below in sub-section “Examples of Force Interaction Models.”

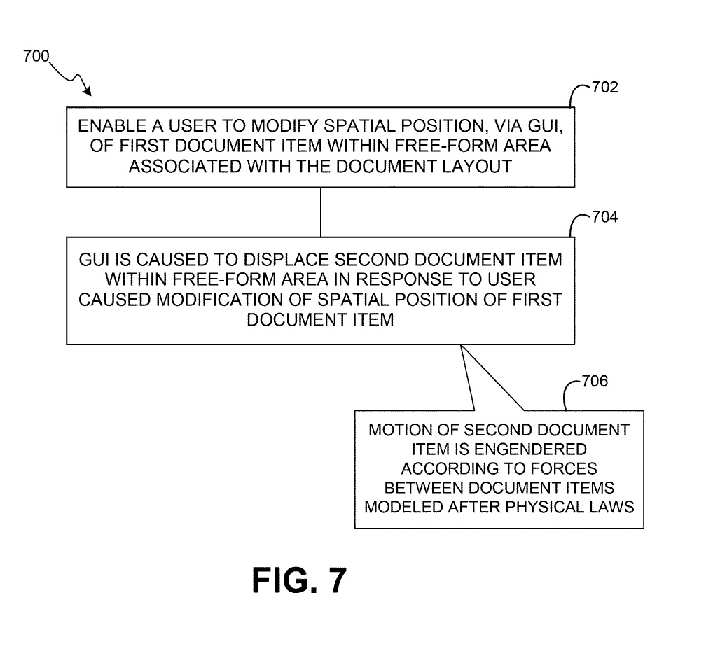

At block 608, document items are caused to move in the GUI according to the computed trajectories at block 606. Some more specific examples on how document items may be caused to move are illustrated with respect to FIG. 7 and FIGS. 8A to 8C below.

FIG. 7 shows a flow diagram 700 illustrating examples of laying out a free-form document containing a plurality of document items. Flow diagram 700 illustrates specific blocks that facilitate causing to move in the visual interface of a GUI such as GUI 200 shown in FIG. 2. Referring to FIG. 3, GUI engine 302 may be responsible for implementing the blocks in flow diagram 600. Operation of flow diagram 700 is illustrated by referring to FIGS. 8A and 8D. FIGS. 8A to 8C show a sequence of snapshots of a GUI portion 800 illustrating the automatically caused displacement of a text item 804 in response to the user displacement of a picture item 802.

At block 702, a user is enabled, via a GUI, to modify the spatial position of a first document item within a free-form area (e.g., free-form area 806) associated with the document layout. In the example of FIGS. 8A to 8C, a user displaces picture item 802 across free-form area using a pointer 808. (The user may also modify the spatial position of picture item 802 by, for example, resizing it.) Referring to FIG. 1, interactive device 106 may be a point and click device (e.g., a computer mouse) that can be used to operate pointer 808 as shown in the example. Arrow 810 indicates the velocity of displacement of picture item 802.

At block 704, the GUI is caused to displace a second document item within the free-form area in response to the user caused modification of the spatial position of the first document item enabled at block 702. The motion of the second document item is subjected to condition 706, namely that motion is engendered according to forces between document items modeled after physical laws.

Referring to the example in FIGS. 8A to 8C, the forces between picture item 802 and text item 804 are modeled after an electrostatic interaction between electrically charged particles (further details on such a force interaction model are set forth below in sub-section “Examples of Force Interaction Models”). As picture item 802 (the lower item) is moved from left to right, text item 804 (the upper item) recedes as picture item 802 approaches. Arrow 812 indicates the velocity of displacement of text item 804. As illustrated by the increasing size of arrow 812, velocity of recession of text item 804 increases as picture item 804 draws closer.

As set forth above with regard to FIG. 3, after deciding the final layout, the user can produce a device independent representation of the document (e.g., a PDF file) through a rendering engine.

Examples of Force Interaction Models

According to examples herein, force interaction models are used to automatically distribute document items in response to user interactions. Such force interaction models are modeled after physical laws. Such force interaction models may be built using traditional physical simulation models, which attempt to replicate real world physics. However, for at least some applications, it might be advantageous to use simplified models aimed to increase user-friendliness of the GUI.

Examples of document items to be included in the model are text chunks, color blocks or pictures. For the sake of modeling, these items may be represented as rectangles. (Other geometries might be used for modeling document items such as, but not limited to, oval geometries or irregular geometries.)

An item i may be defined by its central position (xᵢ, yᵢ), and size (wᵢ, hᵢ). The problem of finding new positions of items (for distribution of document items on a page) can be modeled as an energy minimization approach. This might be performed similarly as to graph drawing methods such as those described by Battista et al in Graph Drawing: Algorithms for the Visualization of Graphs, published by Prentice Hall PTR (Upper Saddle River, N.J., USA) on 1998.

An energy minimization approach reflects forces between document items modeled after physical laws. It will be understood that there are a variety of methods for solving the energy minimization problem. For example, energy minimization can be achieved efficiently with general optimization heuristics such as simulated annealing as described by Fleischer, in the article titled Simulated annealing: past, present, and future, published in WSC '95: Proceedings of the 27^{th} conference on Winter simulation, pages 155-161. In other examples herein, energy minimization can be achieved by force-based simulation. Examples of force-based simulation are illustrated in the following.

In force-based simulation, forces are computed for each time step and document items are caused to move in the GUI accordingly. This approach might be slower than other approaches, however force-based simulation facilitates the user to interact with the system and follow any changes while he works in finding a good placement. Generally, in examples herein, force-directed methods are adapted for enhancing user interaction with the document items. More specifically, it is convenient that document items move smoothly on the page, so that a user is able to easily follow the items and thus feel more familiarized when interacting with the GUI. Accordingly, in some examples herein, a force interaction model may include a velocity parameter for each item i to allow items to move by inertia. Such a velocity parameter for item i can be described by (vxᵢ, vyᵢ).

An equilibrium state of a plurality of document items may be defined as the state that minimizes the total kinetic energy ε, i.e.,

$$ɛ = {\sum }_{i} {w}_{i} {h}_{i} ( v {x}_{i}^{2} + v {y}_{i}^{2} ) .$$

Document item positions and velocities may be computed using any suitable integration method, such as, for example, a simple Euler integration (which is further described below) or Verlet integration. Further, positions and velocities may be explicitly updated in discrete time steps Δₜ, until the plurality of document items reaches an energy minimum, i.e., ε=0. To compute new velocities (and consequently, item placement), forces generated between document items may be computed first as set forth in the following.

There are a variety of manners of modeling forces describing interaction between document items using physical laws. In some examples, the forces are modeled after a repulsion model, in which document items exert repulsion forces to other document items. Thereby, document items tend to be as far apart as possible from each other so that overlapping is prevented. However, if a page is overfull with items, repelling forces might not be enough to prevent items from overlapping In some examples, the GUI may be caused to distribute document items in a manner such that overlapping between document items is avoided. For example, step-shaped forces might be included in the force model. The step-shaped forces may be such that they prevent intersection between items when two items collide.

Forces may be modeled such that every item has an influence on every other item. In other words, visibility issues between document items may not be considered. Further, forces may be computed pairwise. In some examples, the magnitude of the force is based on the distance between document items and their size. More specifically, repulsion forces may be inversely proportional to the distance between items and directly proportional to document item size.

In a more specific example, which is detailed in the following, forces between document items are modeled after the electrostatic interaction between electrically charged particles. A repulsion force between two items might be based on a simplified version of Coulomb's law. For example forces between document items may be modeled using a repulsion force vector f_{u,v} of document item v over u defined as:

f̅_{u,v}=(fx(u,v),fy(u,v)),

fx(u,v)=(qᵥα)/σ²ᵤᵥΔₓ/σᵤᵥ,

fy(u,v)=(qᵥα)/σ²ᵤᵥΔ_{y}/σᵤᵥ,

wherein qᵥ is a charge of document item v, Δₓ is the displacement in x, Δ_{y} is the displacement in y, α is a repulsion constant, and σ_{u v} is a measure of the distance between u and v. In some examples, repulsion constant α can be tuned according to user preferences.

In some examples, distance between two document items is determined between their central positions. Further, the charge parameter q may be set to be proportional to the document item's area. Thereby, overlapping may be prevented since larger items need to be further away from others to avoid overlapping. Distance can also be measured in different ways. Two different approaches for computing σ_{u v} are discussed below.

Since multiple document items may interact with a document item u, a resultant force may be computed so that a repelling direction and intensity is determined in order to move item u. For example, for every item u, a resultant force vector Fᵤ may be computed as:

$${{F}^{->}}_{u} = {\sum }_{v \neq u} {{f}^{->}}_{v u}$$

From the resultant forces, updated velocities and positions can be computed for the next time step as described in the following. Once resultant force vectors are computed for every document item, they can be applied in order to move items for one time step. In some examples herein, velocity and position associated with document items are computed using an Euler integration method. An Euler integration method is based on the computed resultant force vectors. Euler integration is a simple and stable enough alternative for computing velocity and position associated with document items. Moreover, Euler integration is efficient enough to be used in real-time in an interactive system as described herein.

In an example of Euler integration, assuming that an item i is positioned at (xᵢ^{t}, yᵢ^{t}) at a time instant t, position (xᵢ^{t+1}, yᵢ^{t+1}) of document item i at time instant t+1 may be computed as:

xᵢ^{t+1}=xᵢ^{t}+Δₜvxᵢ,

yᵢ^{t+1}=yᵢ^{t}+Δₜvyᵢ,

Velocity may be computed analogously using an Euler integration. In at least some examples herein, velocity associated with document items is computed adding a friction coefficient. Thereby, it is prevented that document items do not settle due to inertial force components. Friction may be implemented in Euler integration as follows:

vxᵢ^{t+1}=(vxᵢ^{t}+Δₜfxᵢ)(1−δ),

vyᵢ^{t+1}=(vyᵢ^{t}+Δₜfyᵢ)(1−δ),

where δ is a friction coefficient in the range 0 to 1, δ=0 being a frictionless model and δ=1 being a static system.

In some applications repulsion forces may not be enough to keep items conveniently distributed within a desired area (e.g., a document page). For example, for the case of a repulsive force model, document items may repel each other apart infinitely far. Therefore, it might be advantageous to incorporate further forces into the GUI in addition to the interaction forces between document items. For example, such further forces may be added so that items are confined within the document page.

More specifically, according to some examples, further forces may be added for constraining document items within the free-form area. For examples, wall forces may be defined, the wall forces acting on document items to keep document items within a specific area of the document. This specific area may be the free-form area of the document, or a more restricted area into which it is desired to restrict a particular type of document items. For example, wall forces may be associated with document boundaries or with other boundaries within the document defining the specific area on which document items should be kept. It will be understood that there are a variety of manners of implementing such wall forces. For example, wall forces may be in the form of a repulsive step force, which repels a document item away from a boundary of the free-form area once it overlaps the boundary.

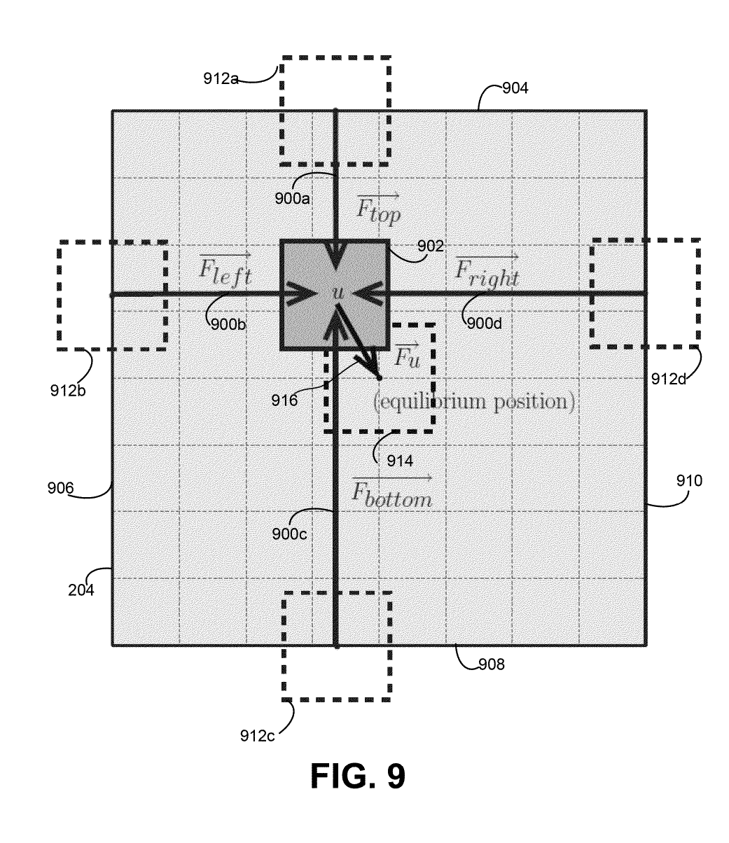

In some examples, wall forces are provided for each border of the page, the wall forces resulting on document items attempting to float towards the center of the free-form area. FIG. 9 shows schematically an example of wall forces 900a-900d (represented by arrows) acting on a document item 902 within a free-form area 204. More specifically, there are four wall forces components, each of them associated with a boundary of free-form area 204: a Ftop force 900a associated with a top boundary 904; a Fleft force 900b associated with a left boundary 906; a Fbottom force 900c associated with a bottom boundary 908; and a Fright force 900d associated with a right boundary 910. As illustrated in FIG. 9, each of these forces corresponds to a virtual force of mirror charges 912a-912d. In an example, each of mirror charges 912a-912d have the same charge as document item 902, i.e., the document item being pushed away from the boundaries. Mirror charges 912a-912d “follow” document item 902 in each axis, so that document item tends to float towards a equilibrium position 914 at the center of free-form area 204, as indicated in FIG. 9 by arrow 916.

When free-form area includes a plurality of document items, wall forces as illustrated in FIG. 9 results in all document items attempting to float towards the center of free-form area 204. The “dispute” for this space facilitates that items are spread evenly over free-form area 204.

For some applications, it might convenient to “glue” a document item at a certain location in the free-form area so that the document item remains in the vicinity of that location. This is referred to as “anchoring” a document item. According to some examples herein, a user is enabled, via the GUI, to anchor a document item to a specific position within the free-form area. For example, the GUI may include an option for adding an anchor point to the free-form area. The GUI may further include another option to associate the anchor point to one or more document items. The user may indicate the location of the anchor point and the association with items by, for example, by a point and click action.

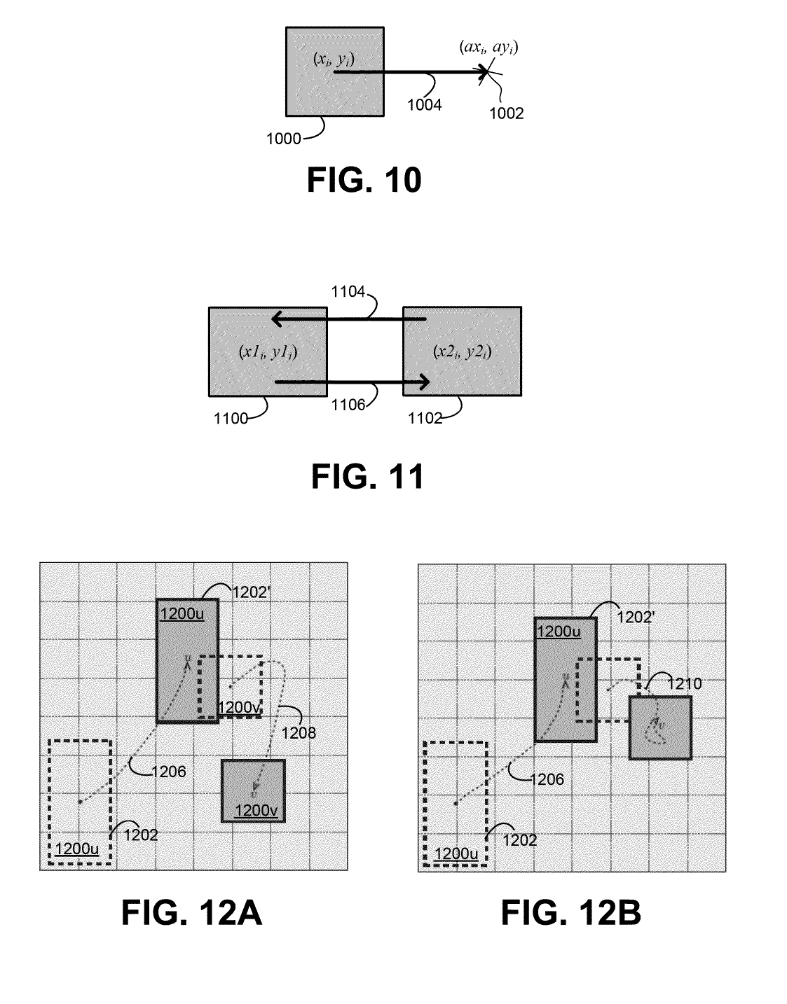

The force model may be adapted for supporting anchoring combining a) an anchor attribute that associates a document item i with an specific position (axᵢ, ayᵢ), and b) an anchor force F_{anchor} to attract document item i to the specific position. An example of such anchoring is illustrated with respect to FIG. 10. Document item 1000 is associated with anchor point 1002. Thereby, anchor point 1002 exerts an attracting force 1004 on document item 1000.

It will be understood that there are a variety of models available to compute an anchoring force. According to some examples herein the anchor force is modeled after a spring model. More specifically, Hooke's law may be used to model the anchor force. Such a model facilitates keeping (xᵢ, yᵢ) close to (axᵢ, ayᵢ), while still allowing the item to move when under excessive pressure.

An spring model for computing an anchor force may be simplified by assuming the spring rest length to be zero, since the desired position for a document item is exactly over its anchor location. For example, an spring force vector F_{anchor} of item i may be described as

F_{anchor}=(gxᵢ,gyᵢ),

gxᵢ=γβΔₓ,

gyᵢ=γβΔ_{y},

where β is the spring stiffness constant, and γ is a user adjustable parameter in the range 0 to 1, Δₓ and Δ_{y} being the displacements in x and y. γ facilitates flexibility since a user may fine tune the forces of individual items by making the distance constraint between an item and its anchor point more or less rigid.

Under some circumstance, anchoring might make the equivalent physical system more unstable due to the amount of movement produced when stretching the spring too far from its anchor point. For more stability, when the virtual string associated with an anchored element is stretched beyond a specific threshold length, the force model can be turned off for that anchored element and the item's position can be directly changed after the other items are moved at the end of the current time step. In this situation, the anchored item may influence other items through physical forces as illustrated herein, but the anchored item is not being affected by them. This forces the spring to shorten and brings the item closer to its original position.

According to some examples a user may be enabled, via the GUI to anchor a document item to another document item. Thereby, it is facilitated that document items end up near the same location after a disruption in the position of document items. This might be performed analogously as set forth above with respect to a static anchor point. Further, the anchoring forces between document items may be computed analogously as illustrated above for a static anchor point.

An example of anchoring between document items is illustrated with respect to FIG. 11. Document item 1100 is associated with document item 1102 such that they are anchored to each other. Thereby, document item 1100 exerts an attracting force 1104 on document item 1102 and document item 1102 exerts an attracting force 1106 on document item 1100. Attracting forces 1104 and 1106 may be modeled after a spring force model as set forth above with respect to static anchoring.

As set forth above, distance between document items may be determined for computing interaction forces. It will be understood that there are a variety of methods for computing such distances. An approach is to determine distance σ_{u v} as an Euclidean distance, i.e.:

σᵤᵥ=\sqrt{(xᵤ−xᵥ)²+(yᵤ−yᵥ)²}.

(Distance may be computed from the centers of the document items.)

However, the way distance is computed may be tuned for facilitating using interaction. For example, distance may be computed in a manner such that after a disruption in the position of document items, the document items can find their equilibrium position in a fast manner. Thereby, it is facilitated that the user can follow and interact with document items. For example, distance between document items may be computed for modeling forces between document items such that, when two document items u and v intersect in the x or y axes, the intersecting axis is cut off from the equation such that the distance σ_{u v} between document items u and v corresponds to:

$${σ}_{u v} = \{ \begin{matrix}\vert {x}_{u} - {x}_{v} \vert if u and v intersects only in the y direction , \\ \vert {y}_{u} - {y}_{v} \vert if u and v intersects only in the x direction , and \\ \sqrt{{( {x}_{u} - {x}_{v} )}^{2} + {( {y}_{u} + {y}_{v} )}^{2}} otherwise .\end{matrix}$$

An axis cut-off approach as set forth above may be more stable than other approaches (e.g., a pure Euclidean approach) under certain circumstance, because as document items come closer to each other, less movement may be generated, causing the physical system to stabilize more quickly. This is illustrated in FIGS. 12A and 12B, which illustrate an example of interaction between two document items 1200u and 1200v. More specifically, these Figures illustrates repelling behavior using different approaches for measuring distance.

FIG. 12A illustrate item's behavior when interaction forces act on both axes (e.g., a pure Euclidean approach as illustrated above). FIG. 12B illustrate item's behavior when interaction forces act in a single axis when colliding (e.g., an axis cut-off approach as set forth above). In FIGS. 12A and 12B, item 1200u is displaced from position 1202 to position 1202′ along trajectory 1206 (e.g., a user drags item 1200u along that trajectory). In the case of interaction forces acting on both axes (i.e., FIG. 12A), item 1200v moves in response to the displacement of item 1200 along a trajectory 1208. Further, in the case of interaction forces acting in a single axis when colliding (i.e., FIG. 12B), item 1200v moves in response to the displacement of item 1200 along a trajectory 1210. As can be appreciated from the Figures, item 1200 v gets repelled differently. Further, as illustrated by the fact that trajectory 1210 is shorter than trajectory 1208, using a single axis model results in a faster stabilization of the repelled document items.

A document layout may be considered to be ready when all document items are stabilized. In other words, a document layout may be considered to be ready, when the total kinetic energy of the document items is equal to zero (e.g., that the total sum of forces at each time step will eventually converge to zero). Therefore, it might be advantageous to facilitate stability of the system composed by the document items in order to ensure convergence. A friction coefficient, as illustrated above, may facilitate that convergence. However, some factors may negatively influence convergence. For example, choosing a too large time step in an Euler integration may cause that force vectors grow large and cause overshooting of the equivalent document system. Moreover, the equivalent system may be altered such that it ends up naturally in an oscillatory behavior.

In some examples, for enhancing stability (i.e., convergence), the time step Δₜ and friction δ parameters can be tuned for different values, depending on the number of items, page size, and others. Under certain circumstances, small time steps may result in a more stable and precise simulation. However, small time steps may also require more processing power for computing the Euler integration. In certain examples, for facilitating that the document items eventually stop without completely freezing (i.e., δ=1), the repulsion constant α and the spring stiffness constant β may be automatically be damped over simulation steps. For example, a relatively small factor, e.g. a factor equal to or smaller than 0.02 or, more specifically, 0.01, may be automatically applied to perform the automatic damping. This damping is applied until the document items stop or the user performs a new operation on the document (e.g., adding a new document item). In the latter case, these constants may be reset to their original values previous to damping. The friction factor may also be automatically increased as more document items are added to the page. Thereby, instability reduction is facilitated.

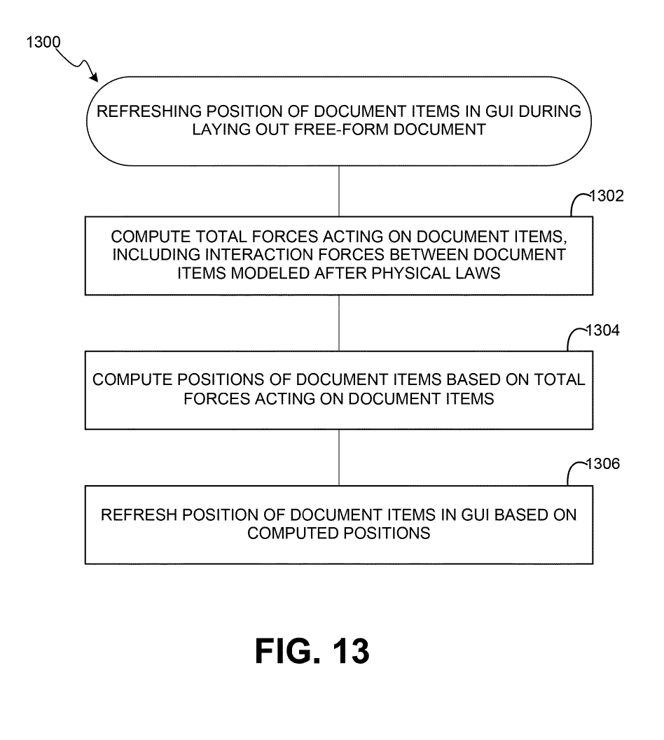

Application of a force interaction model according to examples is illustrated using FIG. 13. More specifically, FIG. 13 shows a flow diagram 1300 illustrating examples of refreshing the position of document items in a GUI during laying out a free-form document. More specifically, flow diagram 600 may be implemented by a computer system as described above with regard to FIG. 1. Referring to FIG. 3, GUI engine 302 may be responsible for implementing the blocks in flow diagram 600.

At block 1302, total forces acting on document items are computed, including interaction forces between document items modeled after physical laws. Examples on how such forces are computed are illustrated above. In some example, as set forth above, the forces may include also at least one of i) wall forces associated with the free-form area boundaries, the wall forces acting on document items to keep document items within the free-form area, ii) anchor forces to anchor a document item to a specific position within the free-form area, or iii) anchor forces to anchor a document item to another document item.

At block 1304, positions of document items are computed based on the forces computed at block 1306. Examples of computing document items are set forth above. In some of these specific examples, position associated with document items is computed using an Euler integration method. At block 1306, the positions of document items in the GUI are refreshed based on the positions computed at block 1304.

The flow diagrams illustrate above facilitates implementation of an interactive authoring method for creating free-form documents based on a force-directed approach. This is used for automatically distributing and manipulating images, text and decorative elements on a page, according to forces modeled after physical laws. Such approach can be used for enabling easy authoring of a number of document types such as, but not limited to, personalized brochures, photo albums, calendars, greeting cards and other free-form documents. Such an approach facilitate users enjoy the experience of designing a page by interacting with it, and that end results can be satisfactory.

In the foregoing description, numerous details are set forth to provide an understanding of the examples disclosed herein. However, it will be understood that the examples may be practiced without these details. While a limited number of examples have been disclosed, numerous modifications and variations therefrom are contemplated. It is intended that the appended claims cover such modifications and variations. Further, flow charts herein illustrate specific block orders; however, it will be understood that the order of execution may differ from that which is depicted. For example, the order of execution of two or more blocks may be scrambled relative to the order shown. Also, two or more blocks shown in succession may be executed concurrently or with partial concurrence. Further, claims reciting “a” or “an” with respect to a particular item contemplate incorporation of one or more such items, neither requiring nor excluding two or more such items. Further, the terms “include” and “comprise” are used as open-ended transitions.

What is claimed is:

1. A system for laying out a free-form document containing a plurality of document items, the system comprising:
a graphical user interface (GUI) engine to manage a GUI for enabling laying out of the free-form document,
the GUI engine enabling a user to modify the spatial position, via the GUI, of a first document item within a free-form area associated with the document layout, and
the GUI engine also causing the GUI to displace a second document item within the free-form area in response to the user caused modification of the spatial position of the first document item, the motion of the second document item being engendered according to forces between document items modeled after physical laws.

2. The system of claim 1, wherein the GUI engine models forces between document items after the electrostatic interaction between electrically charged particles.

3. The system of claim 1, wherein the GUI engine also enables a user, via the GUI, to anchor a document item to a specific position within the free-form area.

4. The system of claim 1, wherein the GUI engine also enables a user via the GUI to anchor a document item to another document item.

5. The system according to claim 1, wherein the GUI engine enables a user to modify the spatial position including at least one of inserting the first document item in the free-form area, moving the first document item, or resizing the first document item.

6. A computer software product comprising a non-transitory medium readable by a processor, the medium having stored thereon a set of instructions for managing a graphical user interface (GUI) to enable a user laying out of a free-form document containing a plurality of document items, the instructions including:
a set of instructions which, when loaded into a memory and executed by the processor, causes the GUI to automatically distribute document items within a free-form area in response to a user modification of the spatial position of another document item in the free-form area, the distribution of document items being performed based on forces between document items modeled after physical laws.

7. The product of claim 6, wherein the instructions further include a set of instructions which, when loaded into a memory and executed by the processor, causes the GUI to distribute document items in a manner such that overlapping between document items is avoided.

8. The product of claim 6, wherein the instructions further include a set of instructions which, when loaded into a memory and executed by the processor, causes the GUI to loosely distribute document items.

9. The product of claim 6, wherein the instructions further include a set of instructions which, when loaded into a memory and executed by the processor, model forces between document items using a repulsion force vector f_{u,v} of document item v over u defined as:
f_{u,v}=(fx(u,v),fy(u,v)),
fx(u,v)=(qᵥα)/σ²ᵤᵥΔₓ/9σᵤᵥ,
fy(u,v)=(qᵥα)/σ²ᵤᵥΔ_{y}/σᵤᵥ,
wherein qᵥ is a charge of document item v, Δₓ is the displacement in x, Δ_{y} is the displacement in y, α is a repulsion constant, and σ_{u v} is a measure of the distance between u and v.

10. The product of claim 9, wherein the charge parameter qᵥ is set to be proportional to the area of document item v.

11. The product of claim 6, wherein the instructions further include a set of instructions which, when loaded into a memory and executed by the processor, compute velocity and position associated with document items using an Euler integration method.

12. The product of claim 6, wherein the instructions further include a set of instructions which, when loaded into a memory and executed by the processor, compute velocity associated with document items adding a friction coefficient.

13. The product of claim 6, wherein the instructions further include a set of instructions which, when loaded into a memory and executed by the processor, causes the GUI to add wall forces associated with the free-form area boundaries, the wall forces acting on document items to keep document items within a specific area of the document.

14. The product of claim 13, wherein there are wall forces for each side of the page, the wall forces resulting on document items attempting to float towards the center of the free-form area.

15. The product of claim 6, wherein the instructions further include a set of instructions which, when loaded into a memory and executed by the processor, enables a user via the GUI to anchor a document item to an anchor point within the free-form area, anchoring being implementing by adding an anchor force acting on the document item to attract the document item to the anchor point.

16. The product of claim 15, wherein the anchor force is modeled after a spring model.

17. The product of claim 6, wherein the instructions further include a set of instructions which, when loaded into a memory and executed by the processor, compute distance between document items for modeling forces between document items, wherein when two document items u and v intersect in the x or y axes, the intersecting axis is cut off from the equation such that the distance σ_{u v} between document items u and v corresponds to:
$${σ}_{u v} = \{ \begin{matrix}\vert {x}_{u} - {x}_{v} \vert if u and v intersects only in the y direction \\ \vert {y}_{u} - {y}_{v} \vert if u and v intersects only in the x direction , \\ \sqrt{{( {x}_{u} - {x}_{v} )}^{2} + {( {y}_{u} + {y}_{v} )}^{2}} otherwise\end{matrix}$$
xᵤ and xᵥ corresponding, respectively, to the position of document items u and v along the x direction, and yᵤ and yᵥ corresponding respectively to the position of document items u and v along the y direction.

18. A method of refreshing the position of document items in a graphical user interface (GUI) during laying out a free-form document, the method comprising:
computing total forces acting on the document items, including interaction forces between document items modeled after physical laws;
computing positions of document items based on the total forces acting on the document items; and
refreshing the positions of document items in the GUI based on the computed positions.

19. The method of claim 18, wherein the forces also include at least one of i) wall forces associated with the document boundaries, the wall forces acting on document items to keep document items within the document boundaries, ii) anchor forces to anchor a document item to a specific position within the document boundaries, or iii) anchor forces to anchor a document item to another document item.

20. The method of claim 18, wherein computing positions of document items includes an Euler integration for determining the positions.
